(19) United States
(12) Patent Application Publication
(10) Pub. No.: US 2015/0007499 A1
(43) Pub. Date: Jan. 8, 2015

(54) MACHINE GUARD ASSEMBLY WITH ELECTRONIC DISCONNECT FOR UNOBSTRUCTED ENGINE HOOD OPENING

(71) Applicant: Caterpillar Inc., Peoria, IL (US)

(72) Inventors: Krishnamoorthy Gurusamy, Chennai (IN); Jagadeesh Subramanian, Chennai (IN); Balasubramany Gupta Narayana Mohan, Trivellore (IN); Rafael Nardo, Wargnies-Le-Grand (FR)

(73) Assignee: CATERPILLAR INC., PEORIA, IL (US)

(21) Appl. No.: 14/494,594

(22) Filed: Sep. 24, 2014

(51) Int. Cl. E05F 15/20; B62D 25/12

(52) U.S. Cl. CPC E05F 15/20; B62D 25/12
USPC 49/31

(57) ABSTRACT

In accordance with one aspect of the present invention, a latching system is provided for use with machines with front or rear guards assembled to protect certain components, that otherwise may get damaged during machine reversing or turning operations in narrow workplaces, such as a mine site. The locking system comprises a hood assembly, a guard assembly, a motor structured and arranged to move the hood assembly between an open and closed position, a sensor to detect position of guard assembly, and a latch assembly. The latch assembly including a support member enables or disables the guard assembly movement. When the guard assembly is in open position it is restricted and simultaneously the sensor urges to interact with a hood operating system that would allow the hood to operate. Alternatively, when the latching system of the guard assembly is unlocked manually, the sensor disables the hood operating system.

### TECHNICAL FIELD

The present disclosure relates to a guard assembly for a machine and more specifically to guard assemblies which pivot to allow access for motor driven engine hood assemblies to provide unobstructed engine hood opening.

### BACKGROUND

Typically, mining machines used in confined spaces such as in a tunneling environment operate in narrow spaces and often require a machine body protection system to protect the front and rear portions of the machine which include hoods and less robust cosmetic parts such as body panels and light assemblies which are vulnerable to damage during reverse or turning operations. These protecting systems are often structurally integrated with frame of machine, so that should an impact occur it can then be relayed to and absorbed by the frame. As a result, body components such as, bumpers, hoods, lamps, doors, etc., are protected by use of such guards.

Guard assemblies which protect moveable engine compartment hoods, which may be opened or closed, have to be positioned so that the normal opening of such hood does not create interference with the guard assembly. For example, if the engine compartment hood is motor driven and manually actuatable, an operator opens the hood by activating a switch typically provided in the operator station. In situations where a large machine incorporates a guard assembly, the hood is operated may be opened via a hydraulic press or motor or may be opened using an electric motor with linkage to open the hood in response to the motor being activated. However, it is difficult for an operator to move the guard assembly prior to activating the switch which opens the hood. In fact, if the hood tilts outwardly from the machine when the hood pivots open then the hood may contact the closed guard assembly which is undesirable. Moreover, an operator may not be able to quickly judge whether the guard assembly is open or closed at the time it is desired to open the hood. In this situation, the operator may be required to exit the machine to confirm the position of the guard and subsequently re-board the machine if the guard is not obstructing the hood. This may cause undue fatigue on the operator and lead to inefficient machine operation. Therefore, a guard system which may overcome one or more of these deficiencies would be desirable.

U.S. Pat. No. 7,992,665B2 discloses a split hood assembly that may be operated in two modes. In the first mode the radiator guard alone may be manually opened and in the second mode, the entire hood assembly may be operated using a powered system. The hood operating or actuating switch is located away from the rear portion of the machine therefore the operator must leave the machine to ensure that the radiator guard is in a closed position prior to activating the hood switch otherwise the hood may contact the radiator guard. As a result the operator must confirm the position of the radiator guard prior to activating the hood assembly which may be time consuming and tedious for the operator.

### SUMMARY OF THE INVENTION

In accordance with one aspect of the present invention, a latching system is provided for use with machines with front or rear guards assembled to protect the softer components such as lamps, hood, doors etc., that otherwise may get damaged during machine reversing or turning operations in narrow workplaces, such as a mine site. The locking system comprises a hood assembly, a guard assembly, a motor structured and arranged to move the hood assembly between an open and closed position, a sensor to detect position of guard assembly, and a latch assembly. Further, the latch assembly includes a support member having a first end and a second end, the first end of the support member being pivotably attached to a hood support structure, the second end having a contact portion and the second end being retained by the guard assembly. A locked position of the support member is defined when the motion of guard assembly is being restricted and clear of the hood. An unlocked position is defined when the support member is re-positioned such that the guard assembly is not restricted. When the guard assembly is in the locked position simultaneously a sensor urges to interact with a hood operating system that would allow the hood assembly to open or close. A manual intervention is required to switch the support member in order to change the locked position of the guard assembly to unlocked position. Through the mechanism of providing the latch system, an accidental enablement of the hood operating system by an operator while the guard is in a position that may obstruct the hood operation is eliminated.

### BRIEF DESCRIPTION OF THE DRAWINGS

FIG. 1 is a perspective view of an exemplary work machine illustrating a rear guard assembly structured to interact with the tilting engine compartment hood for unobstructed movement of the hood according to the present disclosure;

FIG. 2 is a perspective view of the rear portion of work machine of FIG. 1, illustrating the rear guard assembly and the hood assembly opened for allowing access to the engine and maintenance stations;

FIG. 3 is a diagrammatical and schematical view of the rear portion of work machine of FIG. 1, showing a latch assembly to hold the guard assembly opened and the hood assembly is shown in a closed position and portions of a hood disconnect circuit are illustrated in accordance with the present disclosure;

FIG. 4 is a partially exploded and enlarged view of the latch assembly illustrated in FIG. 3;

FIG. 5 is a partial view of the rear guard assembly of FIG. 3 in two positions, one being the open position (solid) and a interim position (dotted line), with the machine and hood assembly removed to illustrate the slider block of the slider assembly in these positions; and

FIG. 6 is an enlarged fragmented view of a portion of the rear guard assembly of FIG. 3, illustrating two positions of a slider block of the slider assembly, one position (in solid line) immediately prior the door is completely opened and the other position (in dotted line) to illustrate the slider in a dropped and locked position corresponding to the door being completely in the open position.

### DETAILED DESCRIPTION

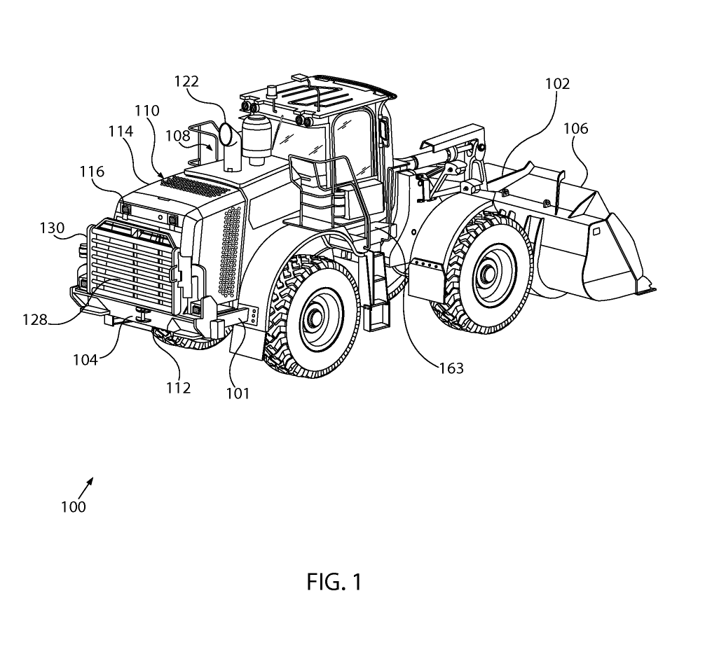

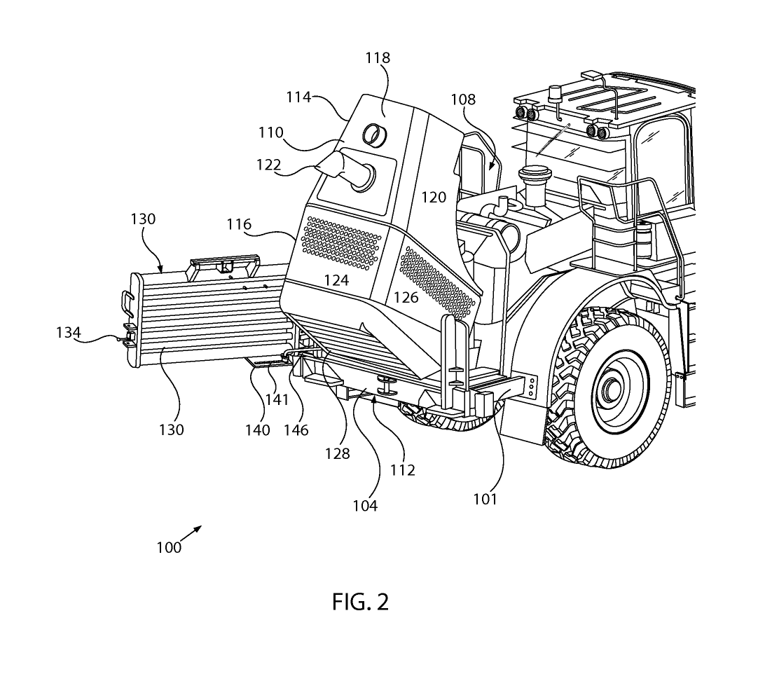

Referring to FIG. 1, a work machine 100 is shown and includes a frame 101, a front portion 102, a rear portion 104, and a bucket 106 which is located at the front portion 102 of machine 102. The rear portion 104 of machine 100 includes an engine compartment 108 (FIG. 2), a hood assembly 110, and a bumper assembly 112. The hood assembly 110 generally encloses the engine compartment 108 as is customary. The bumper assembly 112 extends across the outermost extents of the rear portion 104 of machine 100 to protect the same from low impact contact with surrounding objects. Work machines 100 which operate in harsh environment conditions may benefit from certain machine guarding equipment to protect certain components which may be affected by impact. In an exemplary embodiment, the work machine 100 may be a wheel loader being operated in a mining site for example, however it is contemplated that the present disclosure may be adapted to other machines in many other work environments. A latching system will be explained hereafter that allows the operation of the hood assembly 110 by integrating the operation of a guard assembly 130 with a latching assembly 146, based on the position of said guard assembly 130.

Referring to FIG. 2, the hood assembly 110 includes an engine enclosure 114 and a radiator guard 116. Specifically, the engine enclosure 114 includes a top panel 118, a pair of side panels 120, and an exhaust stack 122 mounted on the top panel 118. The radiator guard 116 forms a portion of the engine enclosure 114 and includes a top panel 124, a pair of sidewall panels 126, and a radiator grill 128 encloses an end of the engine compartment 108 and is connected to the top panel 118 of radiator group 124. In an exemplary embodiment of the disclosure, the radiator guard 116 may be opened and closed using a gas spring (strut) mechanism, which is known to those with ordinary skill in the art.

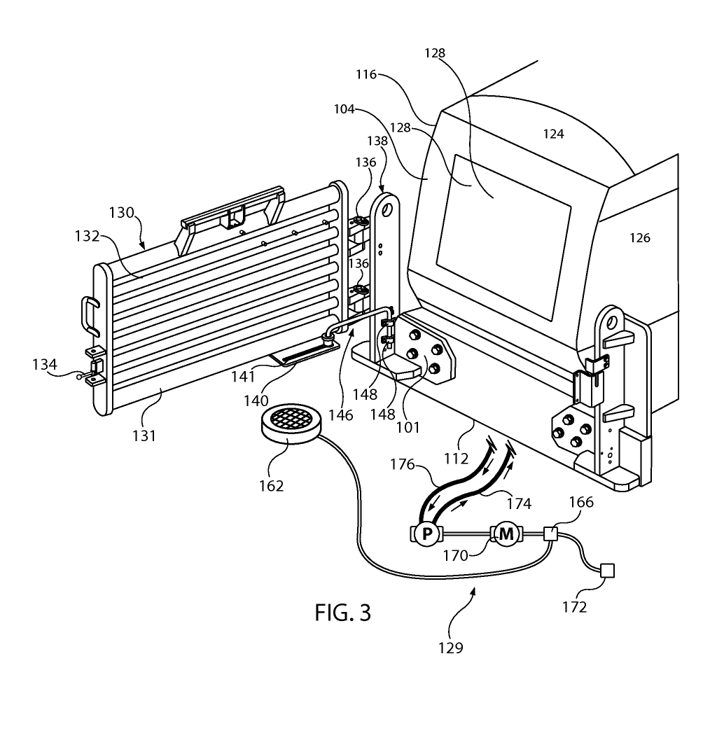

As best seen in FIG. 3, the engine enclosure 114 may be hinged (see FIG. 2) and therefore opened and closed using the hood actuation system 129. The hood actuation system 129 may include at least one actuator or motor 170 which may be an electric motor known to those with ordinary skill or it may be a hydraulically actuator also known to those with ordinary skill, for example. A switch 172 may be provided within the hood actuation system 129 to close or open the circuit, as the case may be, to initiate the opening/closing of the engine enclosure 114. The switch 172 may be placed at a convenient location, such as inside an operator station (not shown) or on the exterior of operator station near the access door of the work machine 100.

The guard assembly 130 of the present disclosure will now be described. Guard assembly 130 is located at the rear portion 104 of the machine 100 and is positioned to generally protect the engine enclosure 114, radiator guard 116, lamps (not shown) and other portions of machine 100 which may be subject to impact and possible damage if an impact event occurred. Such risk of impact may occur, for example, if multiple machines are operated in a small area or during turning and reverse operations of the work machine 100 such as in narrow work sites (i.e., tunnels, mine shafts, etc). In an exemplary embodiment of the present disclosure, guard assembly 130 may be a single piece guard which is adapted to pivot open/closed via two vertically arranged hinges 136. The guard assembly 130 connects to the frame 101 of the machine 102 via an elongated plate-shaped mounting portion 138 of the guard assembly 130.

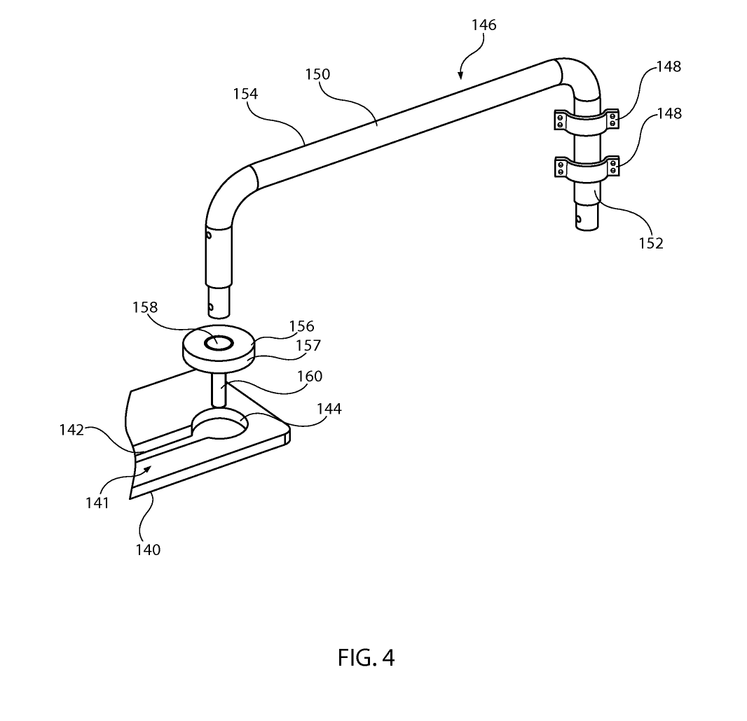

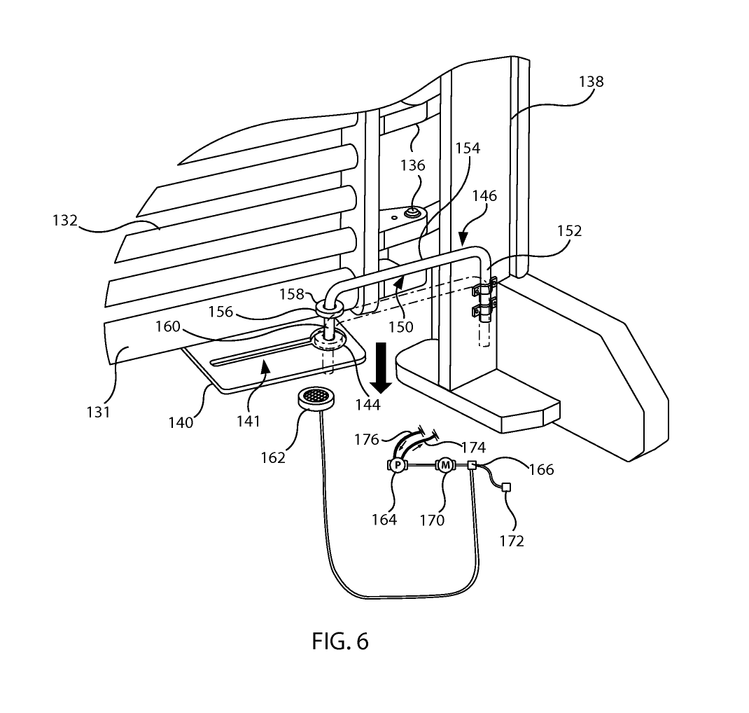

The guard assembly 130 includes a guard panel or door 132, a lock 134, and the pair of hinges 136 and the mounting portion 138. As best shown in FIGS. 3 and 4, the guard assembly 130 further includes a latch support plate 140 attached to the bottom 131 of the door 132. The latch support plate 140 is provided with a grooved portion or slot 141, extending along the width of the door 132. The slot 141 of the latch support plate 140 includes a narrow cut portion or channel 142 which extends along the latch support plate 140 with a circular aperture 144 at the end of the slot 141. The location of aperture 144 coincides with receiving a hat-shaped slider member 156 of a latch assembly 146 when the door is in a fully opened position as will be hereinafter described. The guard assembly 130 also includes latch assembly 146. Latch assembly 146 includes a u-shaped support member 150. Support member 150 includes a hinge end 152 and a locking end 154. Locking end 154 of support member 150 receives the slider member 156 and an outer perimeter portion 157 of the slider member 156 is sized to fit and interlock within the aperture 144 coinciding with the door being fully opened (FIG. 6). In contrast, the hinge portion 152 of the support member 150 is captured (i.e., allowed to rotate and move up and down) by hinge strap 148, and in turn, hinge strap 148 is mounted to the frame 101 of machine 100. Therefore, the hinge portion 152 of support member 150 co-acts with the hinge strap 148 by translating within the hinge strap 148 when the support member 150 is moved upward by an operator and thereafter as the door 132 swings open/closed the hinge portion 152 of support member 150 rotates within hinge strap 148.

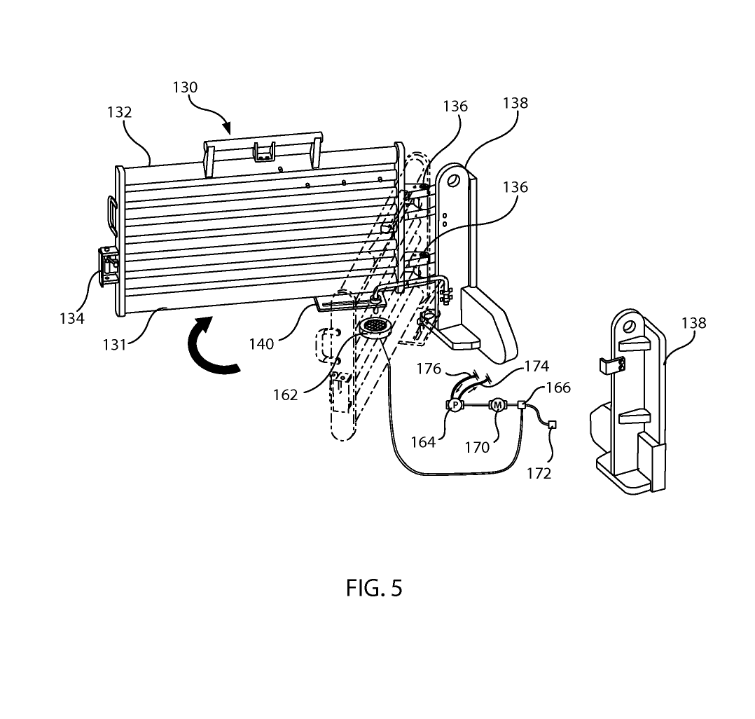

Therefore, the support member 150 can freely rotate about the hinge portion 152 and at the same time the slider member 156 can slide within the slot 141 of the latch support plate 140. The slider block 156 includes a head portion 158 and a body portion 160. The size of the head portion 158 is less than the size of the aperture 144. In FIG. 5, the location of slider block 156 is exaggerated and shown well above the latch support plate 140, for the purpose of explanation. In the exemplary embodiment of the invention, the slider block 156 rests on top of the latch support plate 140.

In an exemplary embodiment of the disclosure, a sensor 162 such as a proximity sensor is placed underneath the aperture 144 of the latch support plate. The sensor 162 is therefore positioned to co-acts with a probe portion 160 of slider member 156, such that as the probe portion 160 drops down into a position when the door 132 is fully opened, and then the probe portion 160 will approach the sensor 162 contemporaneously as the slider member 156 moves through the aperture 144 in the latch support plate 140 to activate the sensor coinciding with the door 132 being fully open (i.e., a locked event). The sensor 162 is electrically connected to an electrical motor 170 with a relay switch 166 therebetween. The electrical motor may be coupled to a hydraulic pump 164 or the electric motor may have a screw driven drive shaft in direct contact with the engine enclosure 114. In an exemplary embodiment, the hydraulic pump 164 may be fitted with hydraulic hoses 174, 176 which are in fluid communication with a hydraulic actuator (not shown) to open/close the engine enclosure 114. It will be understood that the motor 170 may be any other alternative driver to open/close enclosure 114 known to those having ordinary skill in the art.

Referring to FIG. 3, the hood actuation system will now be described. In an exemplary embodiment, the hydraulic pump 164 is coupled to the electrical motor 170. The electrical motor 170 is electrically connected to an electrical switch 172, such as, for example a known on-off toggle type switch. The location of switch 172 may be placed at any convenient location such as within the cab or outside the cab near the cab entry region. The switch 172 may be placed on the platform 163 (FIG. 1) of the machine 100 so that the operator can reach the switch while standing on the ground.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The guard assembly 130 of the present disclosure has the functionality of protecting certain components such as, lamps, bumper, radiator grill, radiator, the engine enclosure, and other non-structural panels, etc., which are externally positioned on the machine 100 and subject to contact. The hood assembly 110 may be operated to open or close by an operator however the swinging guard assembly 130 must first be open and clear of the hood assembly 110. The hood opening mechanism initiates activation of the hydraulic actuator (not shown) to open or close the engine enclosure 114 with suitable force only if the hood activation system is activated coinciding with the door being in the fully open position. If the guard assembly 130 is not fully opened and thus activation of the sensor 162 has not occurred then the motor 170 to open/close the hood assembly 110 will not be activatable.

Referring to FIG. 5, the locking mechanism for the door 132 of the guard assembly 130 includes the support member 150 which allows the door to be opened until it has reached a fully open position then the support member 150 drops and the slider member 156 locks into the aperture 144 of the latch support plate 140, the latch support plate being bolted to the door 132. Further, a sensor 162 co-acts with the slider member 156 by simultaneously activating the hood operating system corresponding with the rod falling into position to activate the proximity sensor. In this manner, the door of the guard assembly must be open and completely out of the way to activate the proximity switch which assures that the door will be open and not obstructing the hood assembly as the hood is opened.

More particularly, as the door 132 of the guard assembly 130 is being rotated from a closed position of the door 132 to a fully open position of the door 132, the head portion 158 of slider block 156 slides over the latch support plate 140, and the body portion 160 of the slider block 156 slides within the narrow cut portion 142. In FIG. 5, the location of slider block 156 is exaggerated and shown well above the latch support plate 140 to illustrate that the probe portion of the slider block is not in proximity with the sensor and should therefore not be activated. The slider block 156 rests on top of the latch support plate 140. This sliding motion of the body portion 160 of slider block 156 within the slot 141 of the latch support plate 140 is defined as ‘swing event’. During the swing event, the motion of slider block 156 of slider assembly 150 is in a horizontal plane.

When the door 132 reaches a fully open position, the head portion 158 of the slider block slips into the large aperture 144, due to gravity. This action of slider assembly falling by weight is defined as the ‘locking event’. After the locking event, the movement of the door 132 is completely restricted. Simultaneously the proximity sensor 162 urges the electrical connection between the switch 172 and the electric motor 170 to a closed circuit. After this circuit between switch 172 and electrical motor 170 is closed, an operator may operate the hood assembly 110 using the toggle switch 172.

Once the hood assembly 110 is closed again using the switch 172, to unlock the door 132, the slider assembly 150 would be manually lifted up such that the bottom face of slider block 156 is above the upper face of latch support plate 140, and guide the body portion 160 of slider block 156 within the narrow cut portion 142 of the latch support plate 140. The lifting of slider assembly 150 would urge the sensor to disconnect the power to the hood operating circuit. Therefore, any further accidental operation of switch 172 by the operator will not cause hood operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A latching system comprising:
a hood assembly;
a guard assembly;
a motor structured and arranged to move the hood assembly between an open and closed position;
a sensor;
a latch assembly, the latch assembly including:
a support member having a first end and a second end; the first end of the support member being pivotably attached to a hood assembly support structure, the second end having a contact portion and the second end being retained by the guard assembly; the support member having a locked position corresponding to the guard assembly being clear of the hood assembly and an unlocked position,
wherein the guard assembly being selectively positioned in the open position corresponds to the support member being positioned in the locked position simultaneously with the second end of the support member urging activation of the sensor to activate the motor.
